(19) United States
(12) Patent Application Publication
(10) Pub. No.: US 2005/0127667 A1
(43) Pub. Date: Jun. 16, 2005

(54) Flexible pipr joint

(75) Inventor: Morihiro Saito, Tokyo (JP)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: Kyodo Rubber Industries Co., Ltd.

(21) Appl. No.: 11/009,673

(22) Filed: Dec. 10, 2004

(30) Foreign Application Priority Data
Dec. 15, 2003 (JP) 416279/2003

(51) Int. Cl. F16F 9/04

(52) U.S. Cl. 285/235

(57) ABSTRACT

A flexible pipe joint has a cylindrical body of soft materials, fitting portions formed at both ends of the cylindrical body, and a plurality of rings of hard materials spaced in the axial direction of the cylindrical body apart from one another and formed on an outer peripheral surface of the cylindrical body other than both ends of the cylindrical body. The cylindrical body has a smooth inner peripheral surface. Axial through holes are formed in the ring so that portions of the cylindrical body are inserted into the holes. A projection is projected inwardly from the inner peripheral surface of the ring, the projections being inserted into the cylindrical body.

### BACKGROUND OF THE INVENTION

1. Field of the Invention

The present invention relates to a flexible pipe joint, and more particularly, relates to a flexible pipe joint usable under a pressure of up to 10 kg/cm² for connecting pipes in a circuit of refrigerant or oil of industrial machines, architectural machines, physical traffic machines, air conditioning machines etc., or water supply and discharge systems.

2. Description of the Prior Art

A flexible hose of bellows type or a flexible hose reinforced by a spiral body has been known as shown in the Japanese Patent Application Laid-Open No. 2002-39451.

However, such conventional flexible hose cannot be expanded and contracted or twisted easily because of the reinforcing spiral body wound around the hose. Further, such conventional flexible hose cannot be used as a joint for connecting two pipes without using a special attachment of soft materials.

### SUMMARY OF THE INVENTION

An object of the present invention is to obtain a flexible pipe joint free from the above defects.

Another object of the present invention is to provide a flexible pipe joint comprising a cylindrical body of soft materials having a smooth inner peripheral surface, fitting portions formed at both ends of the cylindrical body, and a plurality of rings of hard materials spaced in the axial direction of the cylindrical body apart from one another and formed on an outer peripheral surface of the cylindrical body other than both ends of the cylindrical body.

Further object of the present invention is to provide a flexible pipe joint comprising a cylindrical body of soft materials having a smooth inner peripheral surface, fitting portions formed at both ends of the cylindrical body, a plurality of rings of hard materials spaced in the axial direction of the cylindrical body apart from one another and formed on an outer peripheral surface of the cylindrical body other than both ends of the cylindrical body, and a reinforcing member incorporated into the ring.

Yet further object of the present invention is to provide a flexible pipe joint having axial through holes formed in the ring so that portions of the cylindrical body are inserted into the holes.

Still further object of the present invention is to provide a flexible pipe joint having a projection projected inwardly from the inner peripheral surface of the ring, the projections being inserted into the cylindrical body.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a vertically sectional side view of a flexible pipe joint according to the present invention.

FIG. 2 is a front view of an unevenness portion forming ring of the flexible pipe joint according to the present invention.

FIG. 3 is a vertically sectional side view of the ring shown in FIG. 2.

FIG. 4 is a front view of an unevenness portion forming ring of a flexible pipe joint of another embodiment according to the present invention.

FIG. 5 is a vertically sectional side view of the ring shown in FIG. 4.

FIG. 6 is a sectional view of a metal mold for forming a cylindrical body and an unevenness forming ring of the flexible pipe joint according to the present invention as a unit.

### DETAILED DESCRIPTION OF THE PREFERRED EMBODIMENTS

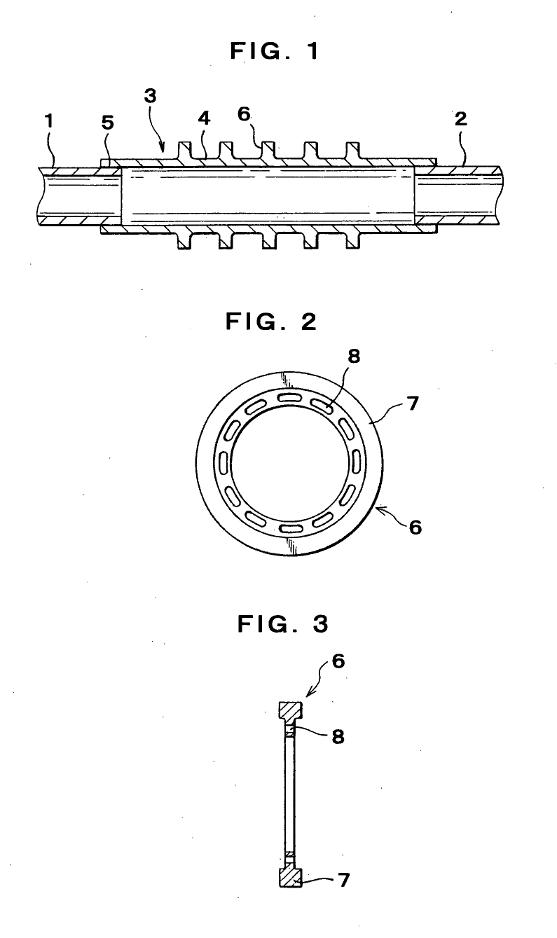

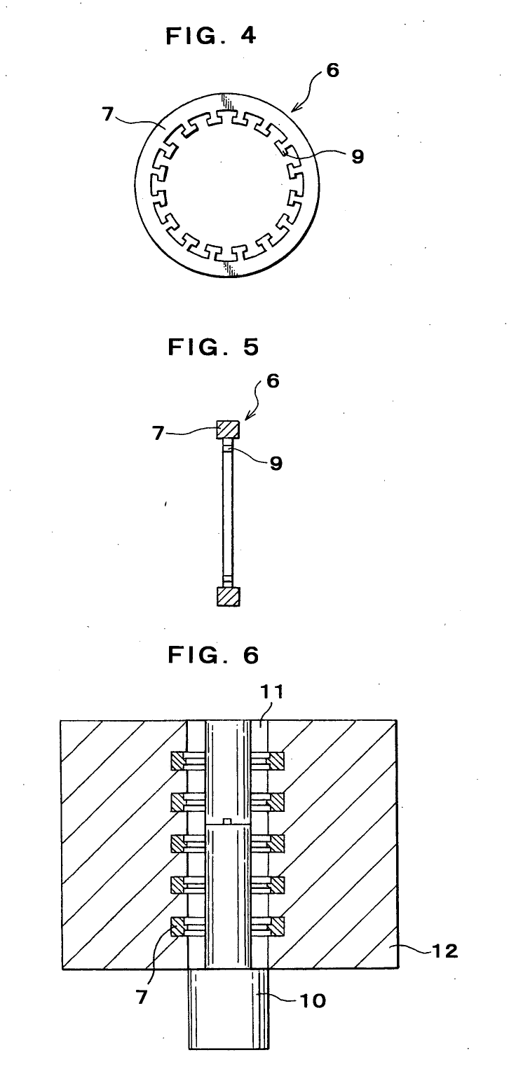

As shown in FIG. 1, in the first embodiment of the present invention, a flexible pipe joint 3 for connecting pipes 1 and 2 comprises a cylindrical body 4 of soft materials having a smooth inner peripheral surface, fitting portions 5 formed at both ends of the cylindrical body 4 to be press fitted to the ends of the pipes 1 and 2, respectively, and a plurality of rings 6 of hard materials spaced in the axial direction of the cylindrical body 4 apart from one another and formed on an outer peripheral surface of the cylindrical body 4.

The cylindrical body 4 is made of soft plastic materials, for example.

Each of the rings 6 is formed of a ring body 7 made of hard plastic materials as shown in FIG. 2 and FIG. 3. The rings 6 are spaced in the axial direction of the cylindrical body 4 apart from one another and fixed on the outer peripheral surface of the cylindrical body 4 other than both ends of the cylindrical body 4 by an adhering agent. The rings 6 can be formed as a unit with the cylindrical body 4 by an injection mold or the like.

It is preferable that a reinforcing member (not shown) is incorporated into the ring body 7, and that axial through holes 8 spaced in a circumferential direction apart from one another are formed in the ring body 7 so that portions of the cylindrical body 4 are inserted into the holes 8 when they are molded.

Instead of forming the axial through holes 8, it is possible to form projections 9 projected radially inwardly from the inner peripheral surface of the ring body 7, the projections 9 being inserted into the cylindrical body 4 when they are molded.

The cylindrical body 4 can be formed of flexible composite materials consisting of vinyl, rubber and metal, for example. According to the necessity, cloth or steel wire may be incorporated therein as a reinforcing member.

It is preferable to make the cylindrical body 4 by hard materials having a D hardness of more than 30° and a JIC hardness of more than 90°, for example.

FIG. 6 shows a metal mold for forming the flexible pipe joint of the present invention. The cylindrical body 4 of the soft materials and the rings 6 of the hard materials are press molded. In FIG. 6, reference numeral 10 denotes a center core of rod type divided axially into two portions and fitted together, 11 denotes a cylindrical body forming portion, and 12 denotes a metal mold.

According to the flexible pipe joint of the present invention, the center core 10 can be removed from the metal mold 12 easily. Further, the fitting portions 5 formed at both ends of the cylindrical body 4 are flexible, so that the fitting portions 5 can be press fitted and secured to the pipes 1 and 2 without using any special attachment, and that the intermediate portion the cylindrical body 4 can be expanded and contracted or twisted easily while maintaining the hardness, because the rings 6 of the hard materials are separated from one another in the axial direction of the cylindrical body 4.

As stated above, the flexible pipe joint according to the present invention is suitable for use as pipe fillings.

While this invention has been described with specific embodiments thereof, it is evident that many alternatives, modifications, and variations will be apparent to those skilled in the art. Accordingly, the preferred embodiments of the invention as set forth herein are intended to be illustrative, not limiting. Various changes may be made without departing from the spirit and scope of the invention. The scope of the present invention should be defined by the terms of the claims appended hereto.

1. A flexible pipe joint comprising a cylindrical body of soft materials having a smooth inner peripheral surface, fitting portions formed at both ends of the cylindrical body, and a plurality of rings of hard materials spaced in the axial direction of the cylindrical body apart from one another and formed on an outer peripheral surface of the cylindrical body other than both ends of the cylindrical body.

2. A flexible pipe joint comprising a cylindrical body of soft materials having a smooth inner peripheral surface, fitting portions formed at both ends of the cylindrical body, a plurality of rings of hard materials spaced in the axial direction of the cylindrical body apart from one another and formed on an outer peripheral surface of the cylindrical body other than both ends of the cylindrical body, and a reinforcing member incorporated into the ring.

3. The flexible pipe joint as claimed in claim 1, further comprising axial through holes formed in the ring so that portions of the cylindrical body are inserted into the holes.

4. The flexible pipe joint as claimed in claim 1, further comprising a projection projected inwardly from the inner peripheral surface of the ring, the projections being inserted into the cylindrical body.

5. The flexible pipe joint as claimed in claim 2, further comprising axial through holes formed in the ring so that portions of the cylindrical body are inserted into the holes.

6. The flexible pipe joint as claimed in claim 2, further comprising a projection projected inwardly from the inner peripheral surface of the ring, the projections being inserted into the cylindrical body.
